(19) United States
(12) Patent Application Publication
(10) Pub. No.: US 2025/0024067 A1
(43) Pub. Date: Jan. 16, 2025

(54) VIDEO ENCODING AND DECODING USING REFERENCE PICTURE RESAMPLING

(71) Applicant: InterDigital CE Patent Holdings, SAS, Paris (FR)

(72) Inventors: Philippe Bordes, Laille (FR); Tangi Poirier, Thorigne-Fouillard (FR); Franck Galpin, Thorigne-Fouillard (FR); Antoine Robert, Mezieres sur Couesnon (FR)

(21) Appl. No.: 18/704,640

(22) PCT Filed: Oct. 7, 2022
(86) PCT No.: PCT/EP2022/077901

§ 371 Date: Apr. 25, 2024

(30) Foreign Application Priority Data
Oct. 28, 2021 (EP) 21306513.9

(51) Int. Cl. H04N 19/52; H04N 19/132; H04N 19/139; H04N 19/176; H04N 19/30

(52) U.S. Cl. CPC H04N 19/52; H04N 19/132; H04N 19/139; H04N 19/176; H04N 19/30

(57) ABSTRACT

In a video coding system, it is proposed to adapt video coding tools to the use of Reference Picture Re-scaling where a reference picture has a different size than the current picture to be coded or decoded. Different embodiments are proposed hereafter, introducing some tools modifications to increase coding efficiency and improve the codec consistency when RPR is enabled. A video encoding method, a decoding method, a video encoder and a video decoder are described.

### TECHNICAL FIELD

The disclosure is in the field of video compression, and at least one embodiment relates more specifically to prediction of a block of a picture using reference picture resampling.

### BACKGROUND ART

To achieve high compression efficiency, image and video coding schemes usually employ prediction and transform to leverage spatial and temporal redundancy in the video content. Generally, intra or inter prediction is used to exploit the intra or inter frame correlation, then the differences between the original image block and the predicted image block, often denoted as prediction errors or prediction residuals, are transformed, quantized and entropy coded. During encoding, the original image block is usually partitioned/split into sub-blocks using various partitioning such as quad-tree for example. To reconstruct the video, the compressed data is decoded by inverse processes corresponding to the prediction, transform, quantization and entropy coding.

Existing methods for coding and decoding show some limitations. Therefore, there is a need to improve the state of the art.

### SUMMARY

The drawbacks and disadvantages of the prior art are solved and addressed by the general aspects described herein.

A first aspect is directed to a method comprising, for a current image obtaining a list of motion vector candidates and associated reference indexes to reference pictures from previously reconstructed blocks of the current image, associating the motion vector candidates with a cost, wherein the cost is set to a default cost when the size of a reference picture is different from the size of the current image; and reordering the list of motion vector candidates according to the cost associated to the motion vector candidates.

A variant of the first aspect comprises determining the cost from samples comprised in a template based on neighboring reconstructed samples. In a variant of the first aspect, the default cost is zero. In a variant of the first aspect, the default cost is an arbitrary large value.

A second aspect is directed to a method for decoding data representative of a block of a picture of a video comprising predicting a block of a picture of a video according to the first aspect or any of its variants; and decoding picture data using the reconstructed block.

A third aspect is directed to a method for encoding data representative of a block of a picture of a video comprising predicting a block of a picture of a video according to the first aspect or any of its variants; and encoding picture data using the reconstructed block.

A fourth aspect is directed to an apparatus for decoding picture data comprising a decoder configured to predict a block of a picture of a video according to the first aspect or any of its variants; and decode picture data using the reconstructed block.

A fifth aspect is directed to an apparatus for encoding picture data comprising a encoder configured to predict a block of a picture of a video according to the first aspect or any of its variants; and encode picture data using the reconstructed block.

According to another general aspect of at least one embodiment, there is provided a non-transitory computer readable medium containing data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

### BRIEF SUMMARY OF THE DRAWINGS

FIG. 1 illustrates a block diagram of a video encoder according to an embodiment.

FIG. 2 illustrates a block diagram of a video decoder according to an embodiment.

FIG. 3 illustrates a block diagram of an example of a system in which various aspects and embodiments are implemented.

FIG. 4 illustrates the principles of Reference Picture Resampling at the encoder side.

FIG. 5 illustrates the principles of Reference Picture Resampling at the decoder side.

FIG. 6 illustrates the principles of Local Illumination Compensation (LIC).

FIG. 7 illustrates the sub-group candidates reordering for Adaptive reordering of merge candidates with template matching (ARMC-TM), also known as Adaptative Merge List (AML).

FIG. 8A illustrates the sub-group candidates reordering process for AML.

FIG. 8B illustrates the sub-group candidates reordering process for AML according to a variant of the second embodiment.

FIG. 9 illustrates the implicit rescaling that is required in some cases for template matching.

FIG. 10 illustrates the process for Adaptive decoder side motion vector refinement (Adaptive DMVR).

FIG. 11 illustrates the process for bilateral matching in the example of mode 0.

FIG. 12A illustrates the conditions required for adding a candidate to the list.

FIG. 12B illustrates the conditions required for adding a candidate to the list according to the fifth embodiment.

FIG. 13A illustrates a flowchart of an example of decoding using reference picture resampling according to at least one embodiment.

FIG. 13B illustrates a flowchart of an example of decoding using reference picture resampling according to at least one embodiment.

### DETAILED DESCRIPTION

Various embodiments relate to a video coding system in which, in at least one embodiment, it is proposed to adapt video coding tools to the use of Reference Picture Re-scaling (RPR) where a reference picture has a different size than the current picture to be coded or decoded. Different embodiments are proposed hereafter, introducing some tools modifications to increase coding efficiency and improve the codec consistency when RPR is enabled. Amongst others, an encoding method, a decoding method, an encoding apparatus, a decoding apparatus based on this principle are proposed.

Moreover, the present aspects, although describing principles related to particular drafts of VVC (Versatile Video Coding) or to HEVC (High Efficiency Video Coding) specifications, or to ECM (Enhanced Compression Model) reference software are not limited to VVC or HEVC or ECM, and can be applied, for example, to other standards and recommendations, whether pre-existing or future-developed, and extensions of any such standards and recommendations (including VVC and HEVC and ECM). Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

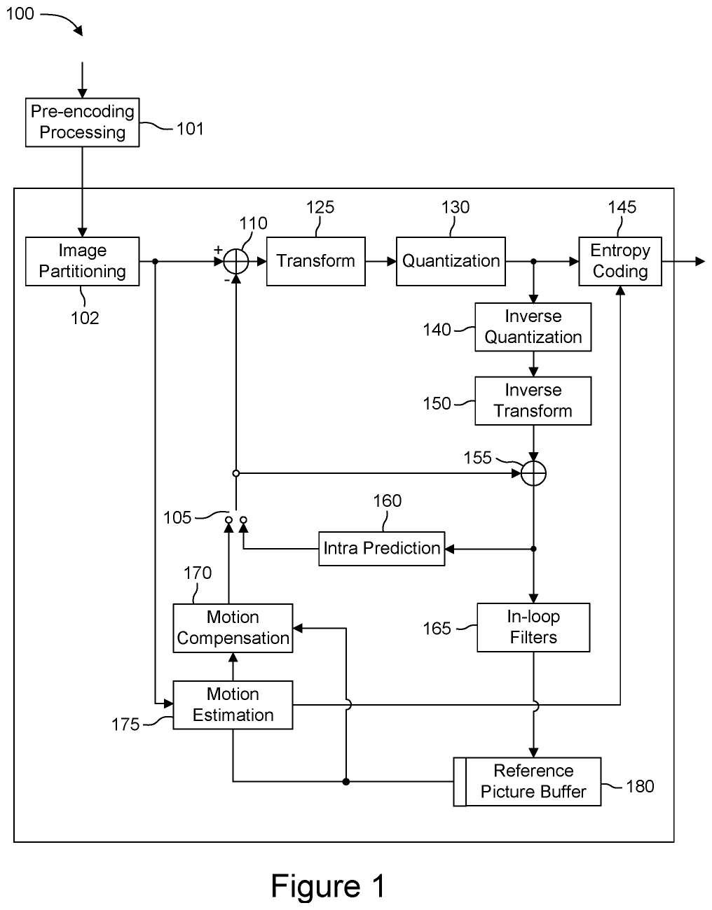

FIG. 1 illustrates a block diagram of a video encoder 100 according to an embodiment. Variations of this encoder 100 are contemplated, but the encoder 100 is described below for purposes of clarity without describing all expected variations. Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components) or re-sizing the pictures before coding. Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and motion compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset), Adaptive Loop-Filter (ALF) filtering to reduce encoding artifacts. The filtered image is stored at a reference picture buffer (180).

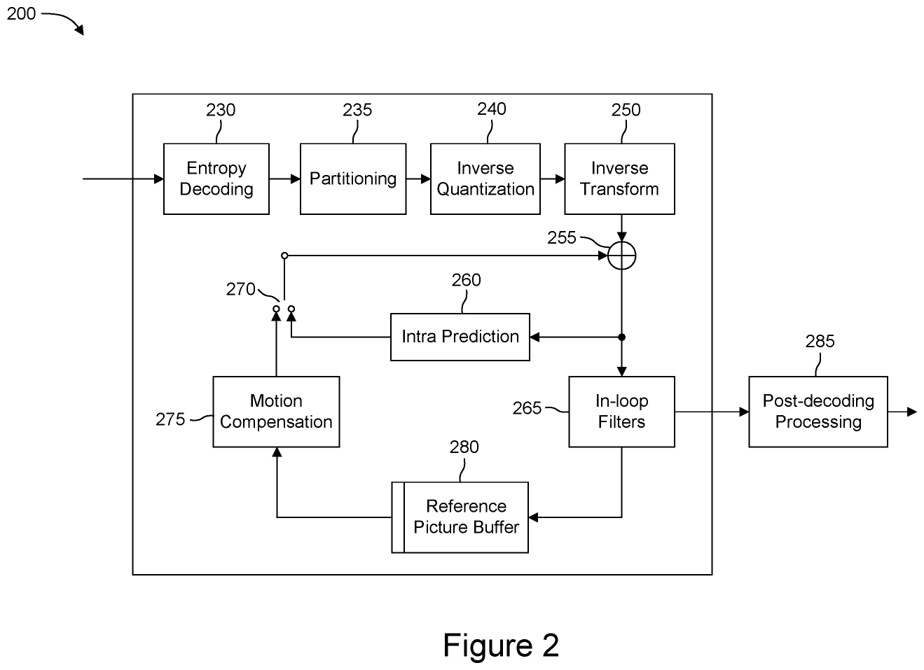

FIG. 2 illustrates a block diagram of a video decoder 200 according to an embodiment. In the decoder 200, a bitstream is decoded by the decoder elements as described below. Video decoder 200 generally performs a decoding pass reciprocal to the encoding pass. The encoder 100 also generally performs video decoding as part of encoding video data. In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280)).

The decoded picture can further go through post-decoding processing (285), for example, an inverse color transform (e.g. conversion from YCbCr 4:2:0 to RGB 4:4:4), decoded picture re-sizing or an inverse remapping performing the inverse of the remapping process performed in the pre-encoding processing (101). The post-decoding processing can use metadata derived in the pre-encoding processing and signaled in the bitstream.

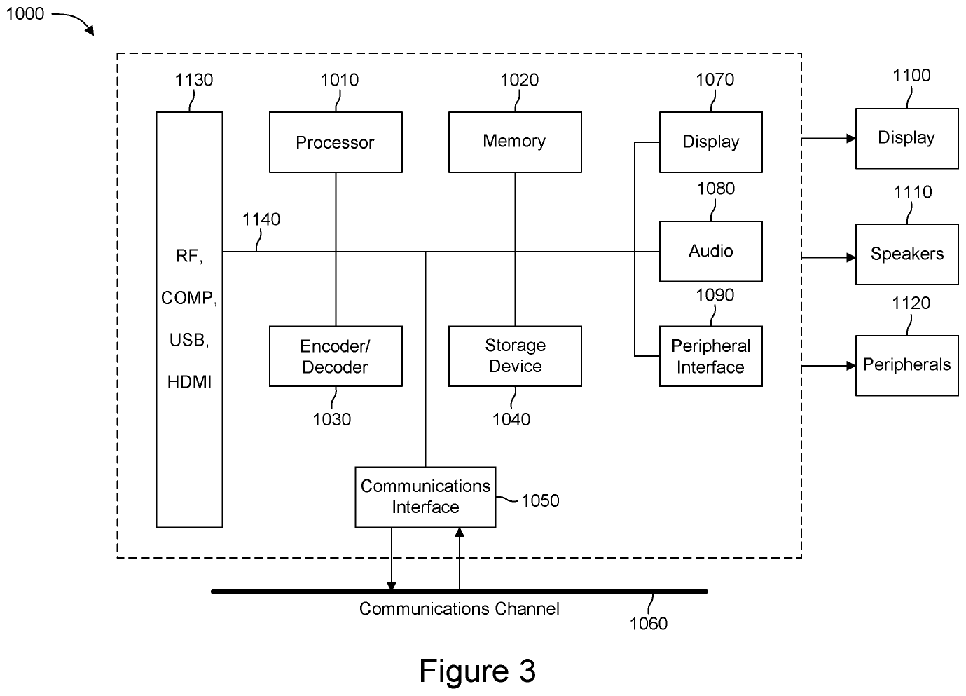

FIG. 3 illustrates a block diagram of an example of a system in which various aspects and embodiments are implemented. System 1000 can be embodied as a device including the various components described above and below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. The processor 1010 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262). HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

A video coding system may comprise a plurality of different tools for encoding and decoding according to different coding modes. A coding mode is selected for a block of image or a larger area of an image or a video according to rate-distortion optimization. Examples of tools are Reference Picture Resampling (RPR), Local illumination compensation (LIC), Adaptive reordering of merge candidates with template matching (a.k.a. ARMC-TM or AML), Template-based intra mode derivation (TIMD), Adaptive Decoder Side Motion Vector Refinement (Adaptive DMVR) and building of motion vector candidates for blocks using bi-prediction amongst others.

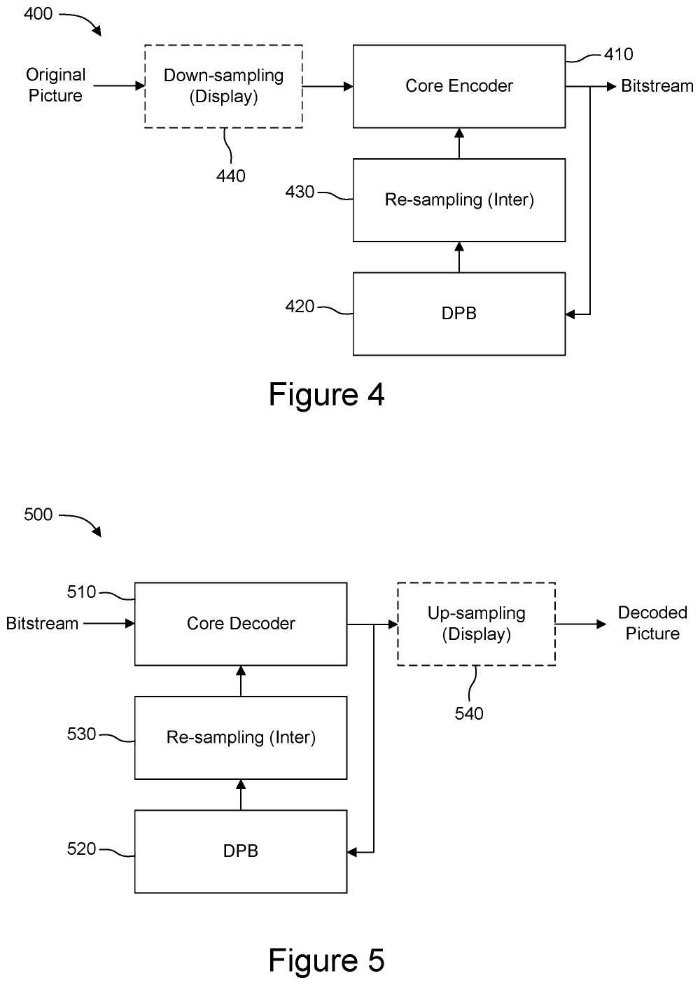

FIG. 4 illustrates the principles of Reference Picture Resampling process 400 at the encoder side, while FIG. 5 illustrates the principles of Reference Picture Resampling process 500 at the decoder side.

Reference Picture Resampling (RPR) is a picture-based re-scaling feature. The principle is that, when possible, the encoding and decoding processes may operate on smaller images which may increase the overall compression rate.

Given an original video sequence composed of pictures of size (width×height), the encoder may choose, for each frame of the video sequence, the resolution (in other words the picture size) to use for coding the frame. Different picture parameter sets (PPS) are coded in the bit-stream with the different possible sizes of the pictures and the slice header or picture header indicates which PPS to use to decode the current picture part included in the video coding layer (VCL) network abstraction layer (NAL) unit.

The down-sampler 440 and the up-sampler 540 functions are respectively used as pre-processing (such as pre-encoding processing 101 in FIG. 1) or post-processing (post-decoding processing 285 of FIG. 2). These functions are not specified by the video coding standard generally.

For each frame, the encoder selects whether to encode 410 at original or down-sized resolution (ex: picture width/height divided by 2). The choice can be made with two passes encoding or considering spatial and temporal activity in the original pictures for example. Consequently, the reference picture buffer (180 in FIG. 1, 280 in FIG. 2, 420 in FIGS. 4 and 520 in FIG. 5), also known as Decoded Picture Buffer (DPB), may contain reference pictures of different sizes than the size of the current picture. In case one reference picture in the DPB has a size different from the current picture, a re-scaling function (430 in FIG. 4 for the encoder side and 530 in FIG. 5 for the decoder side) down-scales or up-scales the reference block to build the prediction block during the motion compensation process (170 in FIG. 1, 275 in FIG. 2) for encoding 410 or decoding 510 the block.

The RPR tool may be enabled explicitly or implicitly at different levels using different mechanisms:
At sequence level: In the sequence parameter sets (SPS) that describes elements common to a series of pictures, a flag indicates that RPR may be applied for coding at least one picture. This is the case in VVC and ECM using a flag named ref_pic_resampling_enabled_flag.
At picture level: if RPR is enabled at sequence level (as above) and current picture uses at least one reference picture with size different from current picture size.
At CU level: if RPR is enabled at picture level and current CU uses at least one reference picture with size different from current picture size.

In the following, the term “RPR enabled” can be understood at any of these levels.

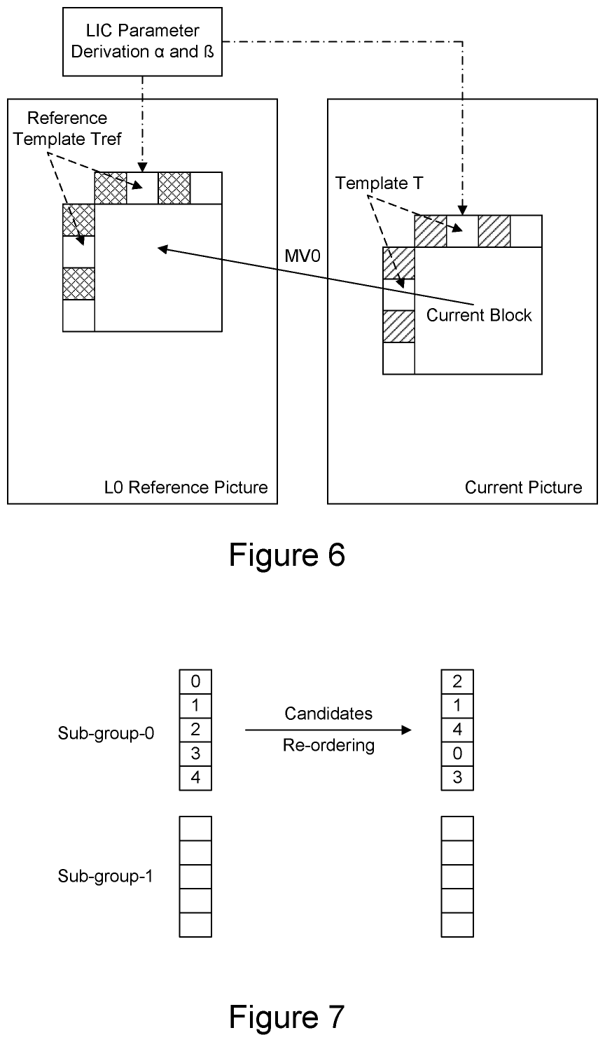

FIG. 6 illustrates the principles of Local Illumination Compensation (LIC). LIC is a coding tool which is used to address the local illumination changes that may exist between the current picture and the reference pictures. The LIC is based on a linear model where a scaling factor α and an offset β are applied to the reference samples after the motion compensation stage (170 in FIG. 1, 275 in FIG. 2) to obtain the prediction samples of a current block. Specifically, the LIC can be mathematically modelled by the following equation:

$$P ( x , y ) = α \cdot {P}_{r} ( x + {v}_{x} , y + {v}_{y} ) + β \qquad ( eq \text{.1} )$$

where P(x,y) is the prediction signal of the current block at the coordinate (x,y). Pᵣ(x+vₓ,y+v_{y}) is the reference block (motion compensation) pointed by the motion vector (vₓ,v_{y}), α and β are respectively the corresponding scaling factor and offset that are applied to the reference block.

When LIC is applied for a current block, a method (e.g. least mean square error (LMSE)) is employed to derive the values of the LIC parameters (i.e., α and β) by minimizing the difference between the neighboring samples of the current block (i.e. the template T) and their corresponding reference samples in the temporal reference pictures (i.e. T_{ref}).

However, in some video coding systems, the LIC tool may be disabled when the reference picture and the current picture have different size (e.g. RPR enabled).

FIG. 7 illustrates the sub-group candidates reordering for Adaptive reordering of merge candidates with template matching (ARMC-TM), also known as Adaptative Merge List (AML). In inter mode, when coding motion vectors, a list of motion vector candidates and associated reference indexes is built from previously reconstructed blocks. The merge candidates can be adaptively reordered with template matching (TM), before the refinement process if any. After a merge candidate list is constructed, merge candidates are divided into several consecutive subgroups. Merge candidates in each subgroup are reordered ascendingly according to cost values based on TM. For simplification, merge candidates in the last but not the first subgroup may be unchanged, i.e. not reordered.

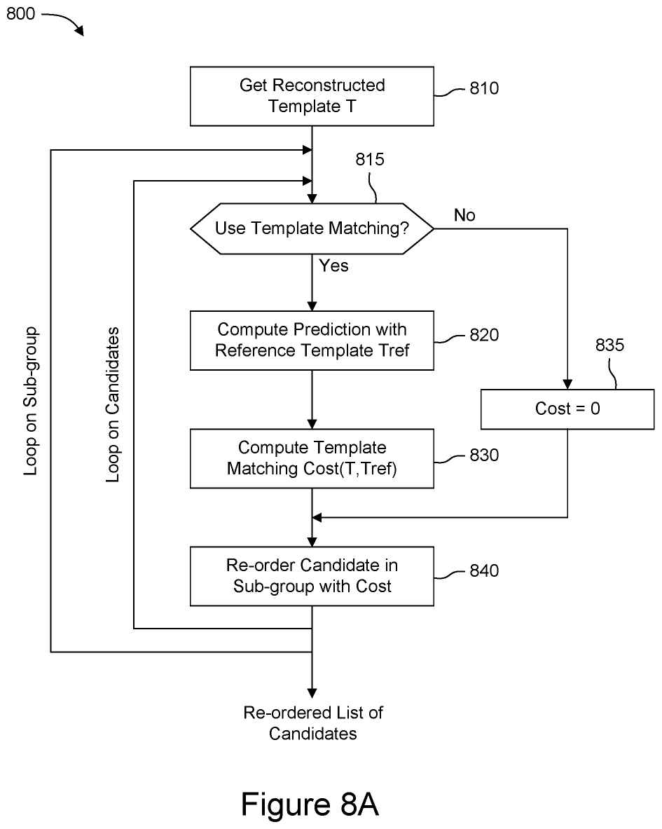

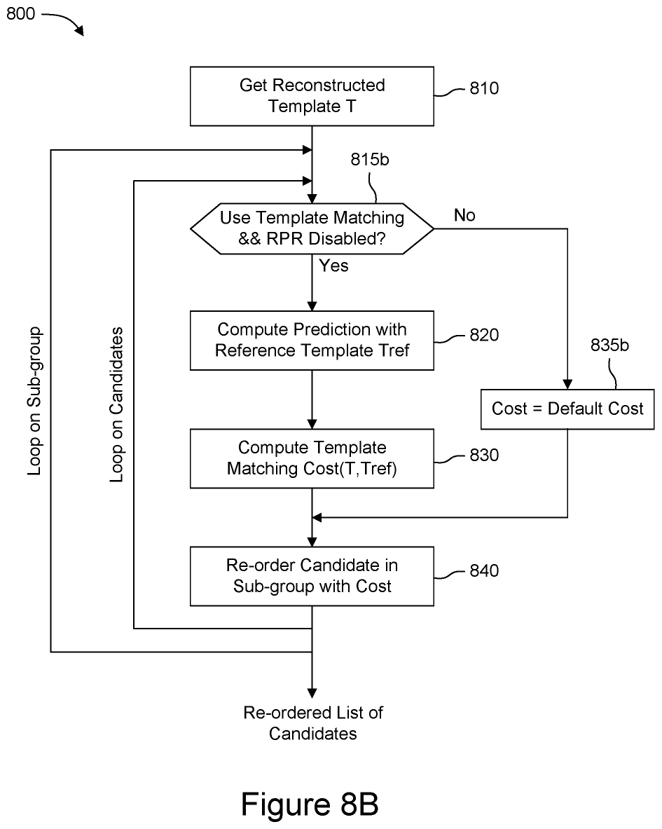

FIG. 8A illustrates the sub-group candidates reordering process for AML. This process 800 iterates through a loop on candidates and a loop on sub-groups. In step 810, the reconstructed template T is obtained. When template matching is used for a candidate of a sub-group, in branch “yes” of the test of step 815, the prediction is computed in step 820 with the reference template Tref. Then, in step 830, the cost of the template matching is computed. The cost of the template matching for a merge candidate is measured by the sum of absolute differences (SAD) between samples of a template of the current block (T) and their corresponding reference samples (Tref). The template T comprises a set of reconstructed samples neighboring to the current block. Reference samples of the template are located by the motion information of the merge candidate and are computed similarly as for the current block prediction samples. In step 840, candidates in the sub-group are re-ordered according to the computed costs. When template matching is not used for a candidate of a sub-group, in branch “no” of the test of step 835, the cost is set to ‘O’ to favor this candidate in step 835 if any of another candidate of the sub-group has non-zero cost. For some sub-groups, the Template matching is not used for all candidates of this sub-group (the candidates are not re-ordered and the cost value is not used or is same for all candidates of the sub-group).

The same re-ordering process is carried out at the decoder side. At the encoder side, an index is coded at CU level to indicate which candidate to use to decode the current CU. The same process may be applied to non-merge candidates. In this case, an additional MVD information (motion vector difference with motion vector candidate) may be encoded. In case of bi-prediction, the list may contain pair of motion vector candidates and one or two MVD values (MVD0, MVD1) may be coded. In case of bi-prediction, if one single MVD is coded, the other one may be derived as (−MVD) or be set to zero.

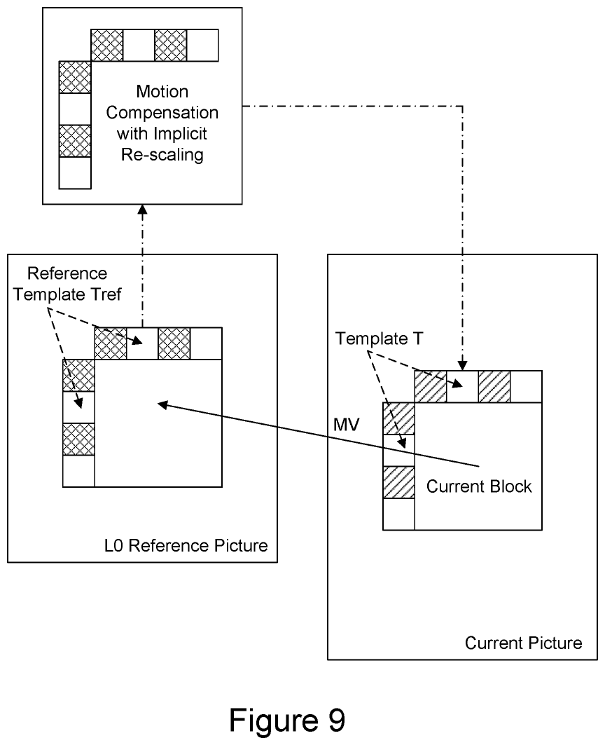

FIG. 9 illustrates the implicit rescaling that is required in some cases. In ECM, in the case where RPR is enabled and the reference picture or block or template has respectively a different size than the current picture or block or template, the motion compensation to obtain the reference template (in step 820 of FIG. 8) may include an implicit re-scaling using the regular RPR process, although this may induce significant complexity. That's why for some candidates (e.g. Affine merge candidates in ECM, in branch “no” of step 815 of FIG. 8), the TM cost is set to a minimal cost (for example ‘0’) when RPR is enabled, which arbitrary may move this candidate on top of the sub-group candidates if Template matching is used for this sub-group.

Another tool is Template-based intra mode derivation (TIMD). With this tool, for a set of intra prediction mode in the list of most probable modes (MPMs), the sum of absolute transformed difference (SATD) between the prediction and reconstruction samples of the template is calculated. First two intra prediction modes with the minimum SATD are selected as the TIMD modes. These two TIMD modes are fused with the weights inversely proportional to SATD cost, and such weighted intra prediction is used to code the current CU. The map of intra modes used for coding is built and is used to derive most probable modes (MPM) with neighboring blocks.

If a neighboring mode is using intra prediction, the intra mode is retrieved from the current map. If a neighboring mode is using inter prediction, the intra mode used to reconstruct the reference samples is used instead of the inter prediction mode by using the map associated with the reference picture. In ECM, when RPR is enabled, the map associated with the reference picture may have different size than the current picture map so that the position in the map associated with the reference picture should be re-scaled appropriately. This may induce significant complexity.

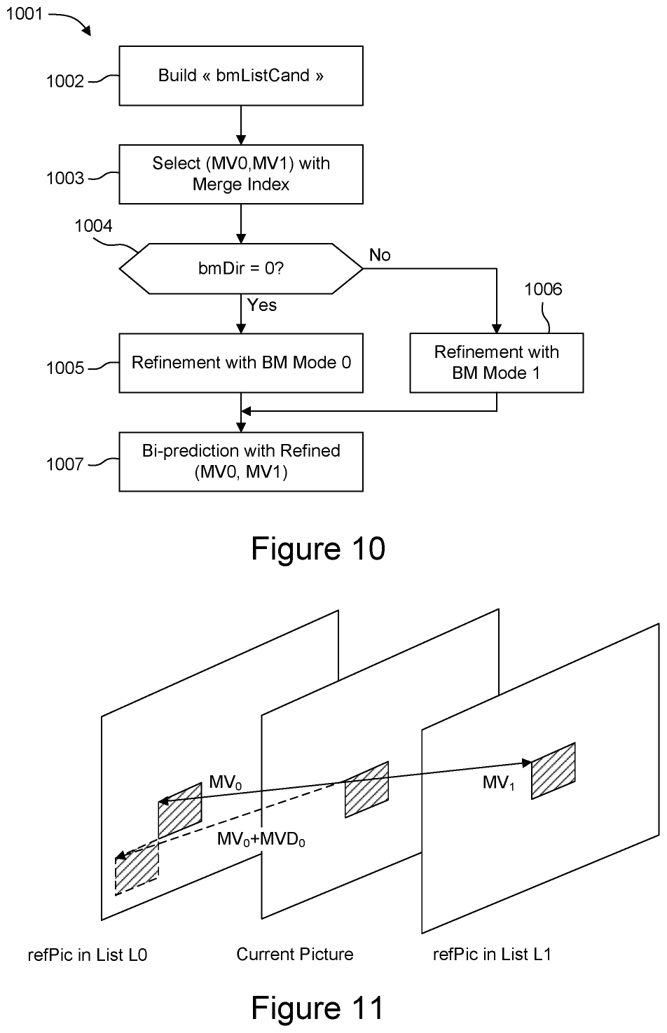

FIG. 10 illustrates the process 1001 for Adaptive decoder side motion vector refinement (Adaptive DMVR). In ECM, the accuracy of the motion vectors of the merge mode is increased using a bilateral-matching (BM) based decoder side motion vector refinement applied in bi-prediction. When Adaptive DMVR applies for the current CU, in step 1002, a list, for example named “bmListCand”, of motion vector pair candidates (MV0, MV1) and associated reference indexes is built from previously decoded MVs. In step 1003, the index (merge index) of the motion vector pair candidate (MV0 and MV1) to use to decode current block is coded at CU level. The BM process is carried out at sub-block level, the current block being divided into 16×16 sub-blocks for example. A refined MV is searched around the two initial MVs (MV0 and MV1) in the reference picture list L0 and reference picture list L1. The refined MVs are derived around the initiate MVs based on the minimum bilateral matching cost between the two reference blocks in L0 and L1. Next, the regular bi-prediction 1007 is carried out using the refined vectors (MV0,MV1).

There are two BM modes (bmDir=0 and bmDir=1). At CU level, a flag “bmDir” is coded indicating which BM mode to apply and is tested in step 1004.

In mode 0, as illustrated in FIG. 11, the SAD between the dashed block in reference L0 and the reference block in L1 based on each MV0+MVD0 candidate values around the initial MV0 is calculated in step 1005. The MVD0 candidate value with the lowest SAD allows deriving the refined MV0 and used to generate the bi-predicted signal possibly. Similarly, in mode 1, in step 1006, the SAD between one block in reference L1 and the reference block in L0 based on each MV1+MVD1 candidate values around the initial MV1 is calculated. The MVD1 candidate value with the lowest SAD allows deriving the refined MV1 candidate and used to generate the bi-predicted signal possibly.

The SAD may be replaced with a cost function taking into account the refinement (MVD0 or MVD1) around the initial MV:

$$bilCost = mvDistanceCost + sadCost \qquad ( eq \text{.2} )$$

In ECM, in case of large CUs (size greater than 64), the sadCost is replaced with mrsadCost applied to remove the DC effect of distortion between reference blocks.

When multi-pass DMVR process is applied in the selected merge candidate to refine the motion vectors, two additional refinement passes are applied. In the second pass, both MV0 and MV1 may be refined with symmetrical values MVD and −MVD respectively. In the third pass, bi-directional optical flow is applied.

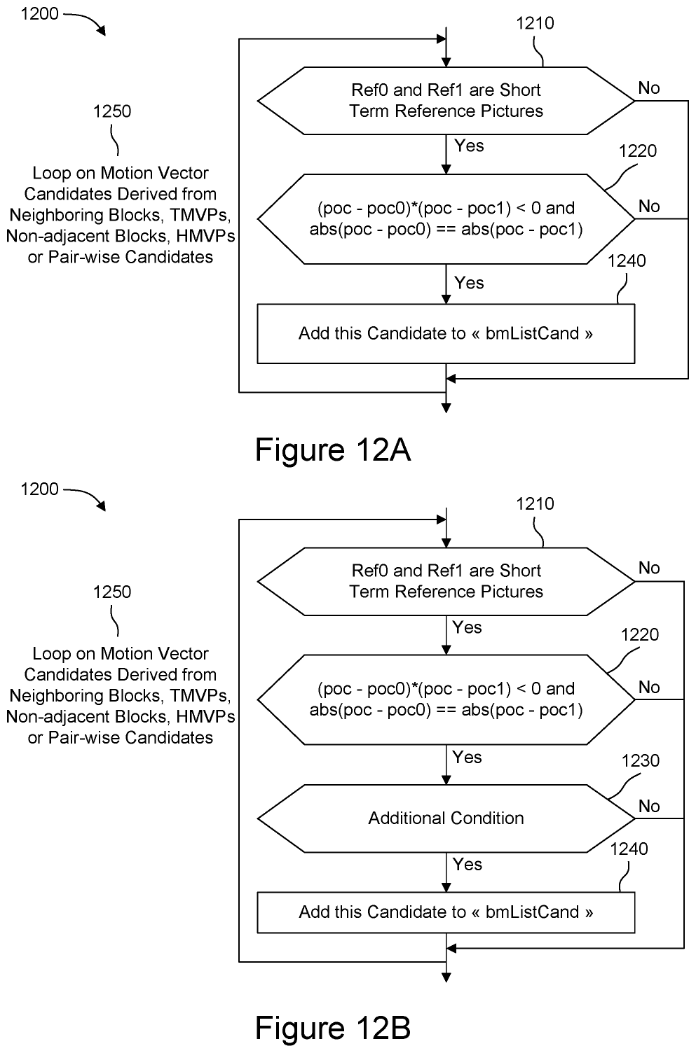

FIG. 12A illustrates the conditions required for adding a candidate to the list. The merge index is coded as in regular merge mode. The list “bmListCand” is a list of pairs of motion vector candidates and reference pictures indexes. This list is derived from spatial neighboring coded blocks, Temporal Motion Vector Prediction (TMVP), non-adjacent blocks, History-Based Motion Vector Prediction (HMVP), pair-wise candidate, similar to what is done for the regular merge mode in a loop iterating on motion vector candidates, as represented by step 1250. The difference with this process is that some additional DMVR conditions need to be met for adding a candidate into the candidate list “bmListCand”. These conditions are verified according to the process 1200 using the following steps:
In step 1210, both reference pictures are short-term reference pictures,
In step 1220, one reference picture is in the past and another reference picture is in the future with respect to the current picture and optionally, the distances (i.e. POC difference) from two reference pictures to the current picture are the same,

When these conditions 1210 and 1220 are fulfilled, the candidate is added to the candidate list “bmListCand” in step 1240.

Similar process for building a list of pair of motion candidate (bmListCand) has been extended to other modes, not only DMVR merge but also AMVP (Advanced Motion Vector Prediction) mode for building the list of bi-prediction candidates, where MVD values may be coded too. The candidates in the “bmListCand” can be re-ordered with bilateral matching (BM) cost, the pair candidates with minimal cost (bilCost) being placed on top of the list.

When building the motion vector candidate lists, co-located motion vectors may be used, a.k.a. temporal motion vector predictor (TMVP). Such motion vectors are picked-up at co-located position from a map of motion vectors and associated reference indexes that is built during the decoding/reconstructing of each picture. The TMVP vector is re-scaled with value proportional to poc difference (pocCur−pocRef). Then, in the DPB, each reference picture is associated with its motion vector map. In the slice or picture header, it is indicated from which reference picture the map of co-located vectors will be used. In the document, the “TMVP mode” will correspond to the case where the index of the candidate is a co-located motion vector.

The use of Reference Picture Re-scaling with the tools introduced above is not straightforward. Indeed, in ECM, some tools may be disabled in case of RPR is enabled, which may reduce the coding efficiency. This is the case of LIC for example. In case of AML, the choice of the most probable motion vector candidates with template matching may be biased if template matching is (partially) disabled. Indeed, setting TM cost to zero if the candidate corresponds to reference picture with different size as current picture size, would arbitrary favor this mode. In case of TIMD, selecting intra mode from reference picture with different size as current picture size may be counterproductive since the signal characteristics are different when picture sizes are different. In case of Adaptive DMVR mode, in case of RPR enabled, the reference pictures may have different size and the reference block too, what may jeopardize the BM process for the calculation of the SAD or MRSAD.

Embodiments described hereafter have been designed with the foregoing in mind. The encoder 100 of FIG. 1, decoder 200 of FIG. 2 and system 1000 of FIG. 3 are adapted to implement at least one of the embodiments described below.

Embodiments generally related to adapting the tools to the use of Reference Picture Re-scaling where a reference picture has a different size than the current picture to be coded or decoded. Different embodiments are proposed hereafter, introducing some tools modifications, in particular for LIC, AML and TIMD to increase coding efficiency and improve the codec consistency when RPR is enabled. These modifications deal with unifying design of coding tools using template matching with RPR enabled, avoiding reference template re-scaling in AML and using another default cost, modifying Template-based intra mode derivation (TIMD) for reference picture re-scaled case, as well as adapting TMVP mode and Adaptive DMVR mode.

In a first embodiment, it is proposed to unify the design of the coding tools using template matching when RPR is enabled.

In a first variant of this embodiment, in order not to increase the coding process, the tools using template matching (LIC, AML, TIMD) are disabled in case where RPR is enabled, in other words when an additional re-scaling process is necessary. For example, LIC is disabled when the reference picture has different size from the current picture (RPR applies for current CU), or if RPR is enabled. Also, AML (merge candidate re-ordering) and TIMD are disabled if RPR is enabled, or if at least one candidate reference index is reference picture with size different from current picture.

In a second variant of this embodiment, in order to improve the coding efficiency in case where RPR is enabled, it is proposed to enable the tools using template matching (ex: LIC, AML, TIMD) by performing RPR re-scaling during the building of the reference template prediction, for the candidates using template matching when RPR is disabled. For example, in case of AML affine merge candidates is true (step 815 of FIG. 8).

In another variant, a syntax element may be coded in the bitstream (ex: SPS, PPS, slice/picture header . . . ), indicating whether template matching based tools are enabled with RPR enabled or not.

In a second embodiment, when the reference picture to be used has a different size than the current picture to be coded or decoded and template matching is used, it is proposed to avoid reference template re-scaling in AML and use another default cost. For AML, to reduce complexity when RPR is enabled, one may set template matching to no (step 815b of FIG. 8B) to avoid motion compensation with implicit re-scaling. In this case, in ECM for example, the template matching cost is set to zero or minimal cost when RPR is enabled, which arbitrary moves this candidate on top of the sub-group candidates and may disadvantage other candidates for which the template matching cost has been computed because the reference has same size as current picture for example.

In variant embodiments, a default matching cost different from zero may be used as illustrated in step 835b of FIG. 8B described below. In a variant, the default matching cost may be set to an arbitrary large value so that this candidate is placed at the end of the sub-group candidates. In another variant, the place of this candidate is un-changed, only candidates for which template matching cost has been computed are re-ordered in-between them. Indeed, the list of candidates (before re-ordering) are made in a logical manner, placing first the most probable candidates.

In this context, an arbitrary large value may be determined for example as the maximal value for the variable storing the cost value, such as the maximal value of a signed 32-bit integer (MAX_INT=2147483647). Another example of arbitrary large value is a fraction of this value (for example half the value of MAX_INT). Another example of arbitrary large value is a value based on the maximal SAD value. For a template of size T_{X}×T_{Y}: this value could be T_{X}×T_{Y}×R_{MAX}, where R_{MAX} is the maximal value of a sample, such as 1024 for a 10-bit sample (or more generally 1<<bitDepthY). In another example, R_{MAX} is a fraction of the maximal value of a sample, such as 256 for a 10-bit sample (or more generally 1<<(bitDepthY−2)).

FIG. 8B illustrates the sub-group candidates reordering process for AML according to a variant of the second embodiment. The process is similar to FIG. 8A, thus the description of steps 810, 820, 830, 840 are identical. The changes are related to step 815b where the process branches to step 835b when RPR is enabled or template matching is not used where the cost is replaced by a default cost.

In a third embodiment, in TIMD mode, if a neighboring mode is using inter prediction, the intra mode used to reconstruct the reference samples is used instead by using the map associated with the reference picture. In case of RPR is enabled, the map associated with the reference picture may have different size from current picture map, and the position in the map should be re-scaled accordingly. Moreover, the intra mode picked up from picture with different size may correspond to intra prediction different from same intra mode with current picture size. It could be preferable to replace it with another mode. For example, a more “blurry” mode such as Planar mode for instance may provide better results.

In another variant, in this case, one may do not fusion two intra modes but use only one. For example, chose the only one with same picture size as current picture, or the first MPM only.

In another variant, one may remove from the list of MPM those coming from reference picture with different size as current picture.

In a fourth embodiment, the co-located reference picture used for TMVP motion vector candidate for example is authorized to have a different size as current picture size. In ECM for example, the co-located reference picture used for TMVP motion vector candidate for example, cannot be a reference picture with different size as current picture size. This may be counterproductive if the reference picture with a picture order count (POC) closer to the current one has different size as current picture size because its motion can be expected to be well correlated with current picture. Enabling that the co-located reference picture used for TMVP motion vector candidate for example, can be a reference picture with different size as current picture size allows to use TMVP motion vector candidates that are re-scaled with a scaling ratio corresponding to the ratio between the current picture size and the reference picture size. In a variant, it is also re-scaled with value proportional to poc difference (pocCur−pocRef). The position of the co-located motion vector is picked up into the reference map after re-scaling of the position of the current block in the current picture.

FIG. 12B illustrates the conditions required for adding a candidate to the list according to the fifth embodiment. In this embodiment, an additional condition is added to the process 1200 of FIG. 12A and needs to be met to add a candidate into the candidate list of pair of motion vectors “bmListCand” (additional step 1230 compared to FIG. 12A).

In a variant embodiment, the condition is that both references in L0 and L1 should have same size (same scaling ratio). This condition is equivalent to determine whether the reference pictures have been re-scaled (step 440 of FIG. 4) with the same parameters before being encoded or not.

In a variant embodiment, the additional condition is that both references in L0 and L1 should have same size than the current picture.

In a variant embodiment, the Adaptive DMVR mode is disabled if RPR is enabled for the current slice, picture, sub-picture, tile or sequence.

In variant embodiment, if a reference blocks has size different from current block, then it is re-scaled before computing the SAD or Mean Removal Sum of Absolute Differences (MRSAD) so the reference blocks have same size than current block. In case of BM used to re-order the “bmListCand”, the templates are re-scaled to be same size as current block template. This can be done within the motion compensation process using the regular RPR motion compensation with implicit re-scaling.

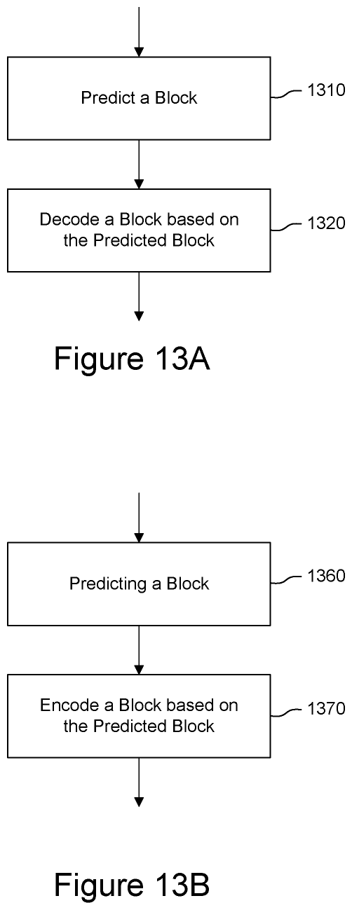

FIG. 13A illustrates a flowchart of an example of decoding using reference picture resampling according to at least one embodiment. This method is for example implemented in a decoder 200 of FIG. 2 or in a decoder 1030 of a device 1000 of FIG. 3. In step 1310, a block is predicted according to at least one of the embodiments described above. In step 1320, picture data of the block of the picture of the video is decoded based on the predicted block.

FIG. 13B illustrates a flowchart of an example of decoding using reference picture resampling according to at least one embodiment. This method is for example implemented in an encoder 100 of FIG. 1 or in an encoder 1030 of a device 1000 of FIG. 3. In step 1360, a block is predicted according to at least one of the embodiments described above. In step 1370, picture data of the block of the picture of the video is encoded based on the predicted block.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 1, 2 and 3 provide some embodiments, but other embodiments are contemplated and the discussion of these figures does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the intra-prediction modules (160, 260), of a video encoder 100 and decoder 200 as shown in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:

a. SDP (session description protocol), a format for describing multimedia communication sessions for the purposes of session announcement and session invitation, for example as described in RFCs and used in conjunction with RTP (Real-time Transport Protocol) transmission.

b. DASH MPD (Media Presentation Description) Descriptors, for example as used in DASH and transmitted over HTTP, a Descriptor is associated to a Representation or collection of Representations to provide additional characteristic to the content Representation.

c. RTP header extensions, for example as used during RTP streaming.

d. ISO Base Media File Format, for example as used in OMAF and using boxes which are object-oriented building blocks defined by a unique type identifier and length also known as ‘atoms’ in some specifications.

e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, tablets, smartphones, cell phones, portable/personal digital assistants, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

Various embodiments may refer to a bitstream. Bitstreams include, for example, any series or sequence of bits, and do not require that the bits be, for example, transmitted, received, or stored. Bitstreams may be stored, for example, on computer-readable media such as optical disks or memory.

In the present application, the terms “reconstructed” and “decoded” may be used interchangeably, the terms “pixel” and “sample” may be used interchangeably, the terms “image,” “picture”, “frame”, “slice” and “tiles” may be used interchangeably. Usually, but not necessarily, the term “reconstructed” is used at the encoder side while “decoded” is used at the decoder side. Also, the terms “reference picture buffer” and “decoded picture buffer” may be used interchangeably.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of an illumination compensation parameter. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types: a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

1-12. (canceled)

13. A method comprising, for a current block of a current picture:
obtaining, from a decoded pictures buffer comprising decoded pictures, a decoded picture comprising one or more reconstructed samples, one or more motion vectors, and a co-located reference picture having a size different than a size of the current picture;
rescaling a position of the current block based on a scaling ratio corresponding to a ratio between the size of the current picture and the size of a co-located reference picture;
rescaling a motion vector candidate based on the scaling ratio, wherein the motion vector candidate is one of the one or more motion vectors co-located at the re-scaled position of the current block in the co-located reference picture; and
performing co-located motion-compensated prediction for the current block based on the rescaled motion vector candidate and one or more samples of the co-located reference picture; and
decoding picture data of the current block.

14. The method of claim 13 further comprising rescaling the motion vector candidate according to a scaling value, wherein the scaling value is based on a difference between a picture order count of the current picture and a picture order count of the reference picture.

15. A method comprising, for a current block of a current picture:
obtaining, from a decoded pictures buffer comprising decoded pictures, a decoded picture comprising one or more reconstructed samples, one or more motion vectors, and a co-located reference picture having a size different than a size of the current picture;
rescaling a position of the current block based on a scaling ratio corresponding to a ratio between the size of the current picture and the size of the co-located reference picture;
rescaling a motion vector candidate based on the scaling ratio, wherein the motion vector candidate is one of the one or more motion vectors co-located at the re-scaled position of the current block in the co-located reference picture; and
performing co-located motion-compensated prediction for the current block based on the rescaled motion vector candidate and one or more samples of the co-located reference picture; and
encoding picture data of the current block.

16. The method of claim 15 further comprising rescaling the motion vector candidate according to a scaling value, wherein the scaling value is based on a difference between a picture order count of the current picture and a picture order count of the reference picture.

17. An apparatus comprising a decoder for decoding picture data, the decoder being configured to, for a current block of a current picture:
obtain, from a decoded pictures buffer comprising decoded pictures, a decoded picture comprising one or more reconstructed samples, one or more motion vectors, and a co-located reference picture having a size different than a size of the current picture;
rescale a position of the current block based on a scaling ratio corresponding to a ratio between the size of the current picture and the size of the co-located reference picture;
rescale a motion vector candidate based on the scaling ratio, wherein the motion vector candidate is one of the one or more motion vectors co-located at the re-scaled position of the current block in the co-located reference picture; and
perform co-located motion-compensated prediction for the current block based on the rescaled motion vector candidate and one or more samples of the co-located reference picture; and
decode picture data of the current block.

18. The apparatus of claim 17 further comprising rescaling the motion vector candidate according to a scaling value, wherein the scaling value is based on a difference between a picture order count of the current picture and a picture order count of the reference picture.

19. An apparatus comprising an encoder for encoding picture data, the encoder being configured to, for a current block of a current picture:
obtain, from a decoded pictures buffer comprising decoded pictures, a decoded picture comprising one or more reconstructed samples, one or more motion vectors, and a co-located reference picture having a size different than a size of the current picture;
rescale a position of the current block based on a scaling ratio corresponding to a ratio between the size of the current picture and the size of the co-located reference picture;
rescale an motion vector candidate based on the scaling ratio, wherein the motion vector candidate is one of the one or more motion vectors co-located at the re-scaled position of the current block in the co-located reference picture; and
perform co-located motion-compensated prediction for the current block based on the rescaled motion vector candidate and one or more samples of the co-located reference picture; and
encode picture data of the current block.

20. The apparatus of claim 19, further comprising rescaling the motion vector candidate according to a scaling value, wherein the scaling value is based on a difference between a picture order count of the current picture and a picture order count of the reference picture.

21. A non-transitory computer-readable storage medium having stored instructions that, when executed by a processor, cause the processor to perform a method according to claim 13.

22. A non-transitory computer-readable storage medium having stored instructions that, when executed by a processor, cause the processor to perform a method according to claim 14.

23. A non-transitory computer-readable storage medium having stored instructions that, when executed by a processor, cause the processor to perform a method according to claim 15.

24. A non-transitory computer-readable storage medium having stored instructions that, when executed by a processor, cause the processor to perform a method according to claim 16.
